(19) United States
(12) Patent Application Publication
(10) Pub. No.: US 2012/0169544 A1
(43) Pub. Date: Jul. 5, 2012

(54) Multi-Frequency Antenna

(75) Inventors: Yu Yen-Hao, Taipei County (TW); Liu Shih-Chia, Taipei County (TW); Chiu Tsung-Wen, Taipei County (TW); Hsiao Fu-Ren, Taipei County (TW)

(73) Assignee: ADVANCED CONNECTEK, INC., Taipei County (TW)

(21) Appl. No.: 13/152,643

(22) Filed: Jun. 3, 2011

(30) Foreign Application Priority Data
Dec. 30, 2010 (TW) 099146897

(51) Int. Cl. H01Q 9/04

(52) U.S. Cl. 343/700 MS

(57) ABSTRACT

A multi-frequency antenna comprises a first conductor, a second conductor, a grounding member, and a third conductor. The first and second conductors are respectively arranged on a first plane and a second plane. The grounding member is arranged on a third plane existing between the first and second planes. The third conductor is connected with the first conductor and arranged on the first plane also. The first and third conductors are respectively coupled to the radiation signals of the second conductor to form a first path and a second path. The first path and the second path have a phase difference of 180 degrees. The present invention features the additional third conductor. The third conductor and the first conductor are coupled to the radiation signals of the second conductor to generate opposite-phase signals. Thus are counterbalanced the interferences among the antenna systems of an identical frequency band.

### BACKGROUND OF THE INVENTION

1. Field of the Invention

The present invention relates to a multi-frequency antenna, particularly to a multi-frequency antenna, wherein radiation conductors of an identical operation frequency band are integrated into a single antenna module.

2. Description of the Related Art

With fast progress of wireless communication technology, RF channels become more and more crowded. Wireless communication technology has expanded from dual-band systems to triple-band or even quad-band systems. In 2007, the industry of notebook computer's antenna has a bigger change: The wireless communication begins to enter the 3G or 3.5G age after the Centrino chip had pushed the maturation of built-in WLAN. Thus, the number of the built-in antennae also increases. The current notebook computers are mainly equipped with built-in antennae. In the Centrino age, there are only two built-in antennae. In the 3G age, there may be 5-6 built-in antennae. The additional antennae include an 802.11n MIMO antenna, two 3G antennae, and even one or two UWB antennae.

After notebook computers joined the mobile communication industry, the manufacturers have to propose a sophisticated antenna design and a superior RF system implementation tactic, in addition to a standard 3 G communication module, so that the notebook computers can transceive signals accurately and noiselessly in a communication environment full of interference. Further, a notebook computer involves many communication systems, such as GPS, BT, Wi-Fi, WiMax, 3G/LTE and DTV. How to achieve an optimized design compatible to these wireless communication systems has been a critical technology in the field. The customers have a very high requirement for the compactness and slimness of notebook computers. How to integrate more and more antenna modules into smaller and smaller space without mutual interference becomes a big challenge for designers.

### SUMMARY OF THE INVENTION

The primary objective of the present invention is to provide a multi-frequency antenna, which has an additional third conductor, wherein a first conductor couples with the radiation signal of a second conductor to form a first path, and wherein the third conductor couples with the radiation signal of the second conductor to form a second path, and wherein a 180-degree phase difference exists between the first path and the second path, and wherein the feed-in signals of the first and third conductors couple with the second conductor to generate opposite-phase signals, whereby is counterbalanced the interference among the antenna systems of an identical frequency band.

Another objective of the present invention is to provide a multi-frequency antenna, wherein radiation conductors of the same operation frequency band are integrated in a single antenna module and disposed on different planes thereof to reduce in-phase interference among the antenna systems of an identical frequency band and miniaturize the antenna module simultaneously.

To achieve the abovementioned objectives, the present invention proposes a multi-frequency antenna, which comprises a first conductor, a second conductor, a grounding member, and a third conductor. The first conductor is arranged on a first plane. The second conductor is arranged on a second plane. The grounding member is arranged on a third plane existing between the first plane and the second plane. The first, second, third planes are arranged on the corresponding surfaces and parallel to each other. The third conductor is connected with the first conductor and arranged on the first plane also. The first conductor is coupled to the radiation signal of the second conductor to form a first path. The third conductor is coupled to the radiation signal of the second conductor to form a second path. The first path and the second path have a phase difference of 180 degrees.

The present invention integrates the radiation conductors of an identical operation frequency band into a single antenna module. In the present invention, the first conductor and the second conductor belong to the same operation frequency band and may interfere with each other. The present invention provides an additional third conductor, makes the first conductor couple with the radiation signal of the second conductor to form the first path, and makes the third conductor couple with the radiation signal of the second conductor to form the second path, wherein a 180-degree phase difference exists between the first path and the second path, and wherein the high-frequency feed-in signals of the first conductor and the third conductor are coupled to the second conductor to generate opposite-phase signals, whereby is counterbalanced the interference among the antenna systems of an identical frequency band.

In the present invention, the radiation conductors of an identical frequency band are integrated in a single antenna module and respectively disposed on different planes of the antenna module, whereby to reduce in-phase interference among identical frequency band antenna systems and miniaturize the antenna module simultaneously.

The embodiments are described in detail to make easily understood the technical contents of the present invention.

### BRIEF DESCRIPTION OF THE DRAWINGS

FIG. 1 is a top view of a multi-frequency antenna according to one embodiment of the present invention;

FIG. 2 is a top view of a first plane according to one embodiment of the present invention;

FIG. 3 is a top view of a second plane according to one embodiment of the present invention;

FIG. 4 is a side view of a multi-frequency antenna according to one embodiment of the present invention;

FIG. 5 is a diagram showing the results of isolation measurement according to one embodiment of the present invention; and

FIG. 6 is a top view of a multi-frequency antenna with feeder cables according to one embodiment of the present invention.

### DETAILED DESCRIPTION OF THE INVENTION

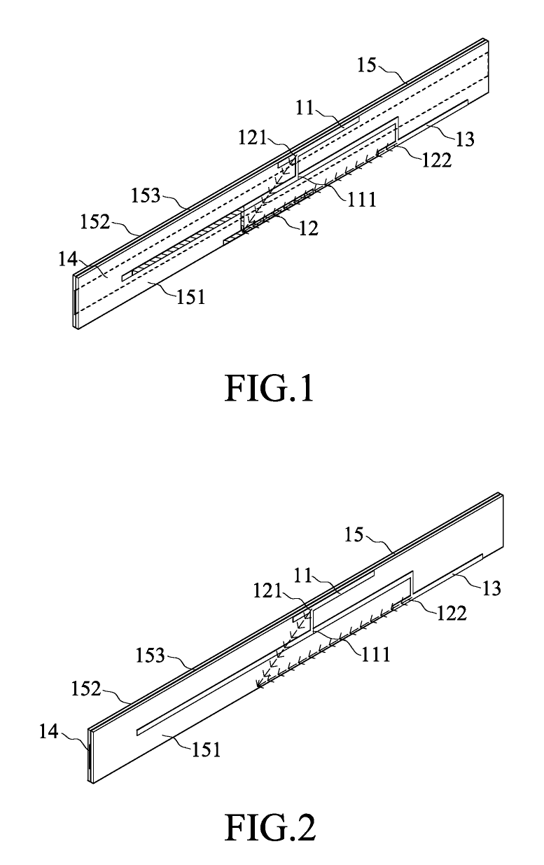

Refer to FIG. 1 a top view of a multi-frequency antenna according to one embodiment of the present invention. The present invention proposes a multi-frequency antenna, which comprises a first conductor 11, a second conductor 12, a grounding member 14 and a third conductor 13.

The first conductor 11 is arranged on a first plane 151. The second conductor 12 is arranged on a second plane 152. The grounding member 14 is arranged on a third plane 153 existing between the first plane 151 and the second plane 152. Gaps exist among the first plane 151, the second plane 152 and the third plane 153. The gap may accommodate air, glass, an acrylic board, or a printed circuit board. In this embodiment, the gap accommodates a printed circuit board. The first plane 151, the second plane 152 and the third plane 153 are respectively disposed on corresponding surfaces and parallel to each other. The positions where the conductors are disposed overlap. The third conductor 13 is connected with the extension interface 111 of the first conductor 11 and disposed on the first plane 151 also. The first conductor 11 couples with the radiation signal of the second conductor 12 to form a first path 121 (indicated by the arrows). The third conductor 13 couples with radiation signal of the second conductor 12 to form a second path 122 (indicated by the arrows). The first path 121 and the second path 122 respectively have different lengths, and a 180-degree phase difference exists therebetween.

In this embodiment, the first conductor 11, the second conductor 12 and the third conductor 13 all belong to antenna systems of an identical operation frequency band and thus may interfere with each other. The present invention features a third conductor 13. The high-frequency feed-in signal of the first conductor 11 is coupled to the radiation signal of the second conductor 12 to form the first path 121. The high-frequency feed-in signal of the third conductor 13 is coupled to the radiation signal of the second conductor 12 to form the second path 122. The first path 121 and the second path 122 have a 180-degree phase difference therebetween. Thus are generated opposite-phase signals when the feed-in signals of the first conductor 11 and the third conductor 13 are coupled to the second conductor 12. Thereby are counterbalanced the interference among the first conductor 11, the second conductor 12 and the third conductor 13, which all belong to antenna systems of an identical frequency band.

In this embodiment, each of the first conductor 11, the second conductor 12 and the third conductor 13 has an about inverted-7 shape including three rectangles. In the first conductor 11, the upper rectangle, which does not contact the extension interface 111, has a length of about 20 mm and a width of about 1 mm; the middle and shortest connection rectangle has a length of about 4 mm and a width of about 1 mm; the lower rectangle has a length of about 43 mm and a width of about 1 mm. In the second conductor 12, the lower rectangle has a length of about 23 mm and a width of about 1 mm; the middle and shortest connection rectangle has a length of about 4 mm and a width of about 1 mm; the upper and longest rectangle has a length of about 29 mm and a width of about 1 mm. In the third conductor 13, the upper rectangle, which contacts the extension interface 111, has a length of about 24 mm and a width of about 1 mm; the middle and shortest connection rectangle has a length of about 4 mm and a width of about 1 mm; the lower rectangle has a length of about 22 mm and a width of about 1 mm. The grounding member 14 is disposed on the third plane 153 and has a rectangular shape with a length of about 102 mm and a width of about 5 mm. The printed circuit board 15 has a rectangular shape with a length of about 102 mm, a width of about 1 mm and a thickness of about 2 mm.

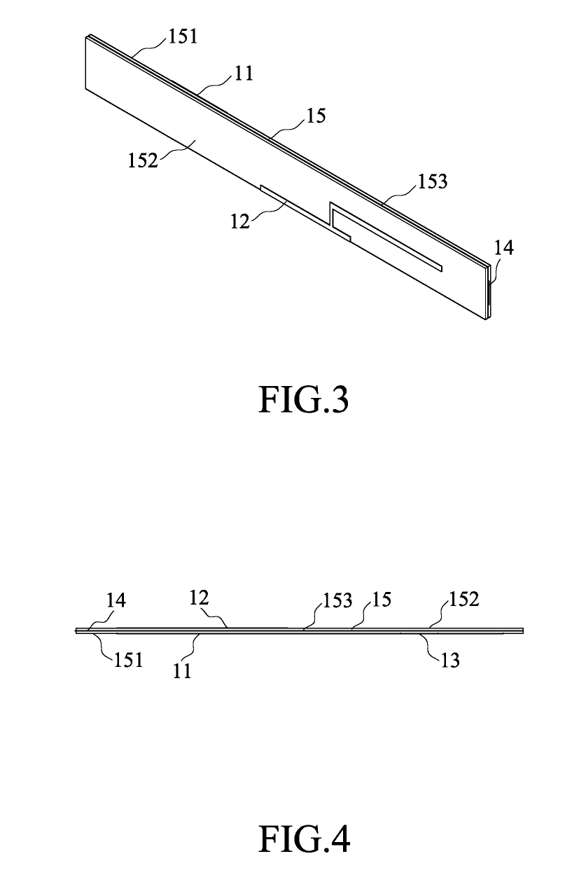

Refer to FIG. 2 and FIG. 3 top views of the first plane and the second plane according to one embodiment of the present invention. The present invention features an additional third conductor 13. The first conductor 11, the second conductor 12 and the third conductor 13 are separately disposed on the first plane 151, the second plane 152 and the third plane 153 of the printed circuit board 15. The first plane 151, the second plane 152 and the third plane 153 are arranged on corresponding parallel surfaces. The positions where the first conductor 11, the second conductor 12 and the third conductor 13 are disposed overlap. The high-frequency feed-in signals of the first conductor 11 and the third conductor 13 are transmitted to the second conductor 12 via the radiation coupling effect, whereby are generated the first path 121 and the second path 122. The first path 121 and the second path 122 have a phase difference of 180 degrees. Thus are generated opposite-phase signals after the first conductor 11 and the third conductor 13 are coupled to the second conductor 12. Thereby are counterbalanced the interference among the three conductors, which belong to identical frequency band antenna systems.

Refer to FIG. 4 a side view of a multi-frequency antenna according to one embodiment of the present invention. In the present invention, the first conductor 11, the second conductor 12 and the third conductor 13 are separately disposed on the first plane 151, the second plane 152 and the third plane 153 of the printed circuit board 15. The design that the radiation conductors are respectively disposed on adjacent parallel planes can effectively reduce the in-phase interference among identical frequency band antenna systems and miniaturize the antenna structure.

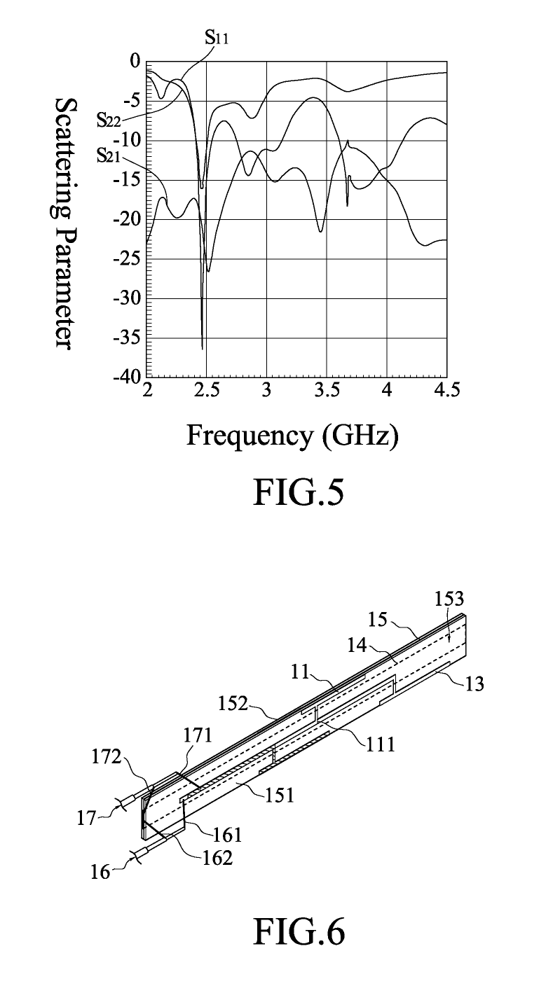

Refer to FIG. 5 a diagram showing the results of isolation measurement according to one embodiment of the present invention, wherein the horizontal axis represents frequencies (GHz) and the vertical axis represents S parameter values (dB). In FIG. 5, the S parameter values of the frequency S11 of the first conductor 11 and the third conductor 13 and the frequency S22 of the second conductor 12 are all lower than −10 dB at the frequency of 2.4-2.5 GHz. It shows that the first antenna represented by the first conductor 11 and the third conductor 13 and the second antenna represented by the second conductor 12 have superior impedance matching. The present invention provides an additional third conductor 13. After the high-frequency feed-in signals of the first conductor 11 and the third conductor 13 are coupled to the second conductor 12, the frequency S21 is even lower than −22 dB, as shown in FIG. 5. It proves that the interference among the identical frequency band antenna systems has been greatly reduced, and that the isolation parameter has been greatly improved. Therefore, the present invention can indeed reduce the interference among the identical frequency band antenna systems.

Refer to FIG. 6 a top view schematically a multi-frequency antenna with feeder cables according to one embodiment of the present invention. When the antenna module of the present invention is integrated with a wireless communication device, a first central wire 161 of a first feeder cable 16 is connected with the first conductor 11, and a first outer wire 162 of the first feeder cable 16 is connected with the grounding member 14. A second central wire 171 of the second feeder cable 17 is connected with the second conductor 12, and a second outer wire 172 of the second feeder cable 17 is connected with the grounding member 14. The plurality of identical frequency band conductors is separately disposed on adjacent different planes of a single printed circuit board 15. Thereby is greatly reduced the space for radiation conductor layout, decreased the wiring complexity, promoted the transmission efficiency of the feeder cables, and avoided the mutual interference of signals.

From the above description, it is known that the present invention possesses utility, novelty and non-obviousness and meets the condition for a patent. Thus, the Inventor files the application for a patent. It will be appreciated if the patent is approved fast.

The embodiments described above are only to exemplify the present invention but not to limit the scope of the present invention. Any equivalent modification or variation according to the scope of the present invention is to be also included within the scope of the present invention.

What is claimed is:

1. A multi-frequency antenna comprising
a first conductor disposed on a first plane;
a second conductor disposed on a second plane;
a grounding plane disposed on a third plane between said first plane and said second plane, wherein said first plane, said second plane and said third plane are disposed on corresponding surfaces respectively and parallel to each other; and
a third conductor connected with said first conductor and disposed on said first plane, wherein said first conductor is coupled to a radiation signal of said second conductor to form a first path, and wherein said third conductor is coupled to a signal of said second conductor to form a second path, and wherein said first path and said second path have a phase difference of 180 degrees.

2. The multi-frequency antenna according to claim 1 further comprising
a first feeder cable, which includes
a first central wire connected with said first conductor; and
a first external wire connected with said grounding member.

3. The multi-frequency antenna according to claim 1 further comprising
a second feeder cable, which includes
a second central wire connected with said second conductor; and
a second external wire connected with said grounding member.

4. The multi-frequency antenna according to claim 1, wherein positions where said first conductor, said second conductor and said third conductor are disposed overlap.

5. The multi-frequency antenna according to claim 1, wherein said first conductor, said second conductor and said third conductor all belong to antenna systems of an identical operation frequency band.

6. The multi-frequency antenna according to claim 1, wherein gaps exist among said first plane, said second plane and said third plane.

7. The multi-frequency antenna according to claim 6, wherein said gaps accommodate air, glass, an acrylic board, or a printed circuit board.

8. The multi-frequency antenna according to claim 1, wherein said first path and said second path respectively have different lengths.
